(19) United States
(12) Patent Application Publication
(10) Pub. No.: US 2002/0140346 A1
(43) Pub. Date: Oct. 3, 2002

(54) METHOD OF MANUFACTURING EL LIGHT EMITTING ELEMENT

(76) Inventor: HIROYOSHI TSUKIYAMA, MORIYAMA-SHI (JP)

Correspondence Address: JOSEPH W PRICE, PRICE GESS & UBELL, 2100 S E MAIN ST STE 250, IRVINE, CA, 92614

(21) Appl. No.: 09/294,919

(22) Filed: Apr. 19, 1999

(30) Foreign Application Priority Data
Apr. 20, 1998 (JP) 10-109077

(51) Int. Cl. B05D 5/12

(52) U.S. Cl. 313/502

(57) ABSTRACT

A high-quality, high-intensity EL light emitting element is manufactured by printing a mixed paste, mixed paste being a dispersion of an organic substance that is a fluorescent substance or a dielectric substance in a binder that is dissolved in a solvent having a higher boiling point than toluene or in a mixture of solvents including the solvent when forming a light emitting layer or an insulation layer according to a screen printing method, and by leaving the printed mixed paste standing for a certain period of time.

### TITLE OF THE INVENTION

This application is based on an application No. 10-109077 filed in Japan, the content of which is hereby incorporated by reference.

### BACKGROUND OF THE INVENTION

(1)Field of the Invention

The present invention relates to a method of manufacturing a high-quality, high-intensity EL light emitting element.

(2)Description of the Related Art

An EL light emitting element, which is used for the backlight of a display device such as a liquid crystal display, has the structure shown in FIG. 1.

FIG. 1 shows that a conventional EL light emitting element 1 has the structure described below. On a polyethylene terephthalate (referred to “PET” in this specification) film 3, on which a front electrode (a transparent electrode) 2 including ITO (indium tin oxide) is formed, a light emitting layer 6 and an insulation layer 9 are arranged in layers. In the light emitting layer 6, fluorescent particles 5 of zinc sulfide and the like that have been doped with copper, manganese, aluminum, and the like are dispersed in an organic binder 4. In the insulation layer 9, high permittivity particles 8 of inorganic barium titanate and the like are dispersed in an organic binder 7. On the insulation layer 9, a back electrode 10 is formed.

For the conventional EL light emitting element 1, the light emitting layer 6 and the insulation layer 9 are generally formed by a screen printing method. A part of a step in the screen printing method is schematically shown in FIG. 2. As shown in FIG. 2, a mixed paste 21 that is the mixture of a binder, a fluorescent substance, and an organic solvent for solving the fluorescent substance and the binder is placed on a mesh texture screen 20 in the screen printing method. The mixed paste 21 is squeezed out of the sieve meshes of the screen 20 using a squeegee 22 so that a light coating of the mixed paste is applied to a substrate 23 (referring to the PET film 3, on which the front electrode has been formed, in this specification). After the vaporization of the organic solvent in the mixed paste 21 and setting of the binder, the insulation layer 9 is formed on the light emitting layer 6. The insulation layer 9 is formed in the same manner as the light emitting layer 6. The mixed paste 21 that is the mixture of a binder, a dielectric substance such as barium titanate, and an organic solvent is placed on the mesh texture screen 20. The mixed paste 21 is squeezed out of the sieve meshes of the screen 20 using a squeegee 22 so that a light coating of the mixed paste is applied to the light emitting layer 6, which has been just formed. The conventional EL light emitting element 1 is formed in this manner.

Here, the explanation of how the conventional EL light emitting element 1 emits light will be given below. A voltage is placed between the front electrode 2 and the back electrode 10 to store electric charges in a dielectric layer. Further a voltage is placed between the front electrode 2 and the back electrode 10 to collide the stored electric charges with the fluorescent substance in the light emitting layer. As a result, the fluorescent substance is excitated, and the conventional EL light emitting element 1 emits light. Consequently, the intensity of the conventional EL light emitting element 1 depends on the amount of electric charges stored in the insulation layer 9.

Unfortunately, since a conventional EL light emitting element is generally manufactured using the screen printing method as has been described, there is a limit to increase the intensity of the conventional EL light emitting element.

More specifically, considering the light emitting mechanism of an EL light emitting element, it is understood that a higher proportion of the fluorescent substance and the substance with high permittivity leads to a higher intensity. Under the conventional screen printing method, however, a higher proportion of the fluorescent substance and the high permittivity substance causes a problem. Interstices appear between the light emitting layer 6 and the insulation layer 9 mainly because of remaining mesh pattern. In such interstices between the light emitting layer 6 and the insulation layer 9, abnormal discharge appears. The abnormal discharge leads to the blacking of the ITO included in the front electrode 2 and the damage of the insulation layer 9. As a result, light emitting can not obtained in minute parts of the EL light emitting element. Even if the intensity of the EL light emitting element is improved as a whole, the quality is lowered.

As a proposed solution to this problem is to provide another insulation layer between the light emitting layer 6 and the front electrode 2 so that the amount of current would be limited. In this case, however, the effect of a higher proportion of the fluorescent substance and the high permittivity substance is not sufficiently obtained.

Another proposed approach to improve the intensity is to increase the amount of the insulation layer 9 just by thinning the insulation layer 9. In this case, however, the light transmissivity of the insulation layer 9 is increased because of the thinner insulation layer 9. As a result, the color of the back electrode (generally black) 10 shows through the insulation layer 9, so that the intensity is reduced.

Apart from the screen printing method, a doctor printing method is used in forming the light emitting layer 6 and the insulation layer 9. According to the doctor printing method, no mesh pattern is left on the surface of a formed layer, so that abnormal discharge in interstices does not appear. On the other hand, when the amount of an inorganic substance (fluorescent substance or high permittivity substance) in the mixed paste 21 is increased, the particles of the inorganic substance are more likely to be broken than in the screen printing method. As a result, the printing accuracy is unfavorably decreased in the doctor printing method. In addition, a broader variety of designs is attained in the screen printing method. As a result, the screen printing method is mainly used in manufacturing an EL light emitting element, and the need for a high-quality and high-intensity EL light emitting element has been increased.

### SUMMARY OF THE INVENTION

It is accordingly the object of the present invention to provide a method of manufacturing a high-quality and high-intensity EL light emitting element. The object may be achieved by the manufacturing method given below.

An EL light emitting element manufacturing method, wherein a mixed paste, the mixed paste being a dispersion of a fluorescent substance or a dielectric substance in a binder dissolved in a solvent that has a higher boiling point than toluene or a mixture of solvents including a solvent that has a higher boiling point than toluene, the mixed paste is printed according to a screen printing method, and the printed mixed paste is left at an ordinary temperature when a light emitting layer or an insulation layer is formed.

The aforementioned object may be achieved since the frequency of the interstice occurrence due to the remaining mesh pattern is decreased, as described later, according to the EL light emitting element manufacturing method even when the proportion of an inorganic substance included in a layer is increased.

The inorganic substance proportion suitable for forming an insulation layer or a light emitting layer according to the EL light emitting element manufacturing method is at least 75% by weight of the insulation layer or a light emitting layer.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 shows the structure of an EL light emitting element common to both of a conventional EL light emitting element and an EL light emitting element according to the embodiment of the present invention;

FIG. 2 is a perspective drawing for explaining the screen printing method;

FIG. 3 is a plot showing relations among high permittivity substance proportion, intensities, and currents according to experimental results; and

FIG. 4 is a plot showing relations between fluorescent substance proportions and intensities according to experimental results.

### DESCRIPTION OF THE PREFERRED EMBODIMENT

The explanation of the method of manufacturing an EL light emitting element according to the embodiment of the present invention will be given below.

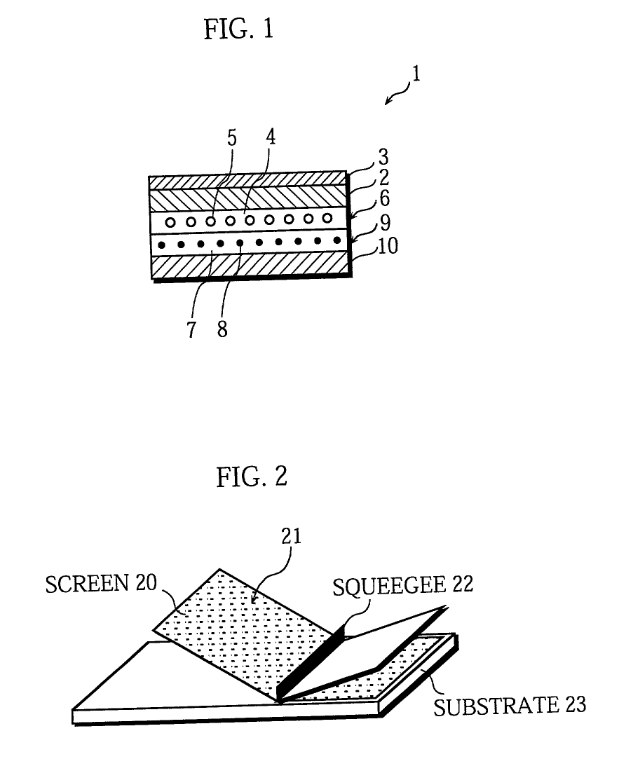

The structure of an EL light emitting element according to the present embodiment is basically the same as that of the conventional EL light emitting element 1 (shown in FIG. 1), which has been described. The EL light emitting element differs from the conventional EL light emitting element 1 in two ways. First, the proportions of the fluorescent substance and the high permittivity substance in the light emitting layers and the insulation layers are different. Second, the thicknesses of the light emitting layers and the insulation layers are different.

More specifically, the proportion of the fluorescent substance in the light emitting layer is set to be equal to or larger than 75% by weight, and the thickness is set to be equal to or less than 40 μm. The high permittivity substance proportion is set to be equal to or larger than 75% by weight of the insulation layer, and the thickness is set to be equal to or less than 35 μm. Note that the fluorescent substance may be zinc sulfide or zinc cadmium sulfide that is doped with copper, manganese, aluminum, silver, chlorine, boron, and the like, and is coated by silicon oxide and aluminum oxide, and the like, or oxide particles of such as yttrium oxide that are doped with rare earth elements and coated by silicon oxide, aluminum oxide, and the like. Here, the fluorescent substance emits a different color such as blue, green, orange and the like according to the kind and the amount of metal used in doping. The high permittivity substance may be barium titanate, titanium oxide, or the like.

By setting the proportion of the fluorescent substance and the high permittivity substance and setting the thickness of each of the layers as has been described, the intensity of the EL light emitting element is improved and the power consumption is reduced. More specifically, the intensity is improved by the increase of the fluorescent substance proportion since the amount of the fluorescent substance per unit of space is increased. The intensity is improved by the increase of the high permittivity substance proportion since the permittivity of the insulation layer is improved and the amount of the capacitance is increased. At the same time, the increased amount of the capacitance and a higher proportion of the fluorescent substance in the light emitting layer than in the conventional EL light emitting element has a noticeable synergistic effect on the intensity improvement. In addition, according to the structure that has been described, the thickness of each of the layers is less than in the conventional EL light emitting element. As a result, decreased voltage reduces the power consumption while the increased amount of capacitance improves the intensity.

Such an EL light emitting element in which a high intensity is obtained with lower power consumption is quite useful for the backlight in the display of the portable electric equipment such as a pager (a beeper) and a portable telephone. A portable electric equipment requires a power-thrifty, high-intensity EL light emitting element that is compact in size.

In order to improve the intensity and to reduce the power consumption, it is desirable to set the fluorescent substance proportion and the high permittivity substance proportion as high as possible. Too high a proportion, however, is problematic because the amount of the binder used in forming each of the layers is too small. Under the circumstances, the particles of the fluorescent substance and the high permittivity substance can be broken, and the mesh pattern can be left in the screen printing method. In some cases, the mixture of the binder and the inorganic substance such as the fluorescent substance or the high permittivity substance cannot be appropriately printed, decreasing the printing accuracy. As a result, the intensity is lowered and the power consumption is increased. Consequently, it is favorable to set the proportion of the fluorescent substance in the light emitting layer to be equal to or lower than 92% by weight and the high permittivity substance proportion to be equal to or lower than 90% by weight of the insulation layer.

On the other hand, it is desirable to set the thickness of each of the light emitting layer and the insulation layer as thin as possible in order to improve the intensity and to decrease the power consumption. An insulation layer and a light emitting layer that is too thin are problematic, however. Too thin an insulation layer is likely to be broken. In too thin a light emitting layer, the effect of improving the intensity by filling the fluorescent substance in high density may not be obtained. As a result, it is desirable to set the thickness of both of the insulation layer and the light emitting layer to be equal to or greater than 15 μm.

Note that the thickness of the insulation layer and the light emitting layer may be set to be thinner than those in a conventional EL light emitting element because the proportions of the fluorescent substance and the high permittivity substance are increased at the same time. In this case, no problem accompanying the increase of the light transmissivity appears. In other words, the intensity is not reduced since the back electrode does not show through the insulation layer.

The explanation of how light emitting layer and the insulation layer in which the fluorescent substance proportion and the high permittivity substance proportion are increased are formed using the screen printing method is given below. Here, an EL light emitting element that has advantages in intensity and power consumption is manufactured by improving the composition of the mixed paste for forming the light emitting layer and the insulation layer.

More specifically, a closely-packed multilayer element in which not only the proportion of the fluorescent substance or the high permittivity substance is increased but also the frequency of the occurrence of interstices in a layer and between layers is reduced is formed. In the multilayer element, the frequency of interstice occurrence is reduced, so that the frequency of abnormal discharge occurrence is also reduced. In addition, the frequency of abnormal discharge occurrence is reduced without a current restriction layer between the front electrode and the light emitting layer, so that the multilayer element is relatively thin and the structure is simple. Furthermore, in the EL light emitting element in which the frequency of abnormal discharge occurrence is reduced, the insulation layer is not broken and the front electrode formed by the ITO does not black. In other words, the EL light emitting element is a high-quality one.

Specifically, the EL light emitting element is manufactured in the manner given below.

First, a light emitting layer is formed on a front electrode substrate that is a PET film onto which the ITO is evaporated. The light emitting layer is formed according to the screen printing method so that the proportion of a fluorescent substance, which has the shape of a particle, and the thickness are set at the numerical values that have been described.

More specifically, a mixed paste is squeezed out of a mesh texture screen using a squeegee so that a light coating of the mixed paste is applied to the front electrode substrate. The mixed paste is the mixture of the fluorescent substance, a binder of organic macromolecules, and an organic solvent for solving the fluorescent substance and the binder.

After the screen printing of the mixed paste, the formed light emitting layer is left for a predetermined period of time at a predetermined temperature so that a leveling effect, which will be explained later, is obtained. The predetermined period of time is about 10 minutes, for instance, although it depends on the environmental temperature and the amount of the binder and the solvent in the mixed paste. The predetermined temperature is an ordinary temperature from 20° C. to 40° C., for instance, although it may be any temperature at which the solvent does not vaporize. As a result, the leveling of the printed layer proceeds, and a light emitting layer with less pinholes and a smoother surface is obtained.

In the mixed paste, the binder that has been dissolved by an appropriate amount of an organic solvent (a binder dissolution solvent) is blended with the fluorescent substance so that the proportion of the fluorescent substance in the nonvolatile ingredients (the fluorescent substance and the binder) is equal to or higher than 75% by weight. As a result, the ratio between the fluorescent substance and the binder in the mixed paste that are both nonvolatile ingredients corresponds to the ratio between the fluorescent substance and the binder in the formed layer.

The viscosity of the mixed paste as a whole is set to be suitable for the screen printing (40 to 50 Pa.s) by adjusting the amount of the binder dissolution solvent.

The composition of the mixed paste used here differs from that of a conventional one. More specifically, the organic solvent as the binder dissolution solvent is more resistant to vaporizing than a conventional binder dissolution solvent such as toluene and ethyl acetate. In other words the organic solvent in the present embodiment has a higher boiling point (a lower vapor pressure at a predetermined temperature) than a conventional binder dissolution solvent. As a result, the leveling effect is obtained by leaving the mixed paste standing that has been squeezed out of the mesh texture screen and placed on the substrate, i.e., that has been printed.

The explanation of the leveling effect will be given below. The binder before setting flows into the interstices among adjacent fluorescent substance particles to bridge the interstices, pushes out pinholes, and fills the parts where no paste has been placed just after the printing (a mesh pattern).

As a result, it is necessary to keep the fluidity of the binder until the binder flows into the interstices, pinholes, and the like. The fluidity of the binder is kept before the vaporization of the solvent for dissolving the binder. In other words, when the solvent vaporizes, the leveling effect is not obtained. As a result, it is desirable that the solvent for dissolving the binder and for giving the binder fluidity has a vaporizing resistance as high as possible. In addition, the higher the fluorescent substance proportion, the less the binder amount and the more frequently the mesh pattern is left. As a result, the higher the fluorescent substance proportion, the greater the necessity to use the solvent that is resistant to vaporizing.

In a conventional screen printing method, the emphasis is put on the solubility of the binder, so that toluene or ethyl acetate, for which a binder has a high solubility, is used as the binder dissolution solvent. In fact, it is beneficial to use a solvent such as toluene or ethyl acetate since a wide variety of binder may be used. The leveling effect, however, is not obtained. More specifically, the solvent has a lower boiling point, so that when the mixed paste is placed in a layer, the surface of the layer dries and sets before the surface is smoothed. As a result, when the insulation layer is further formed on the surface of the layer, the amount of interstices between the light emitting layer and the insulation layer is not reduced.

In order to solve the problem, an organic solvent that has a higher boiling point than toluene and ethyl acetate is used in the present embodiment. More specifically, acid methoxybuthyl (boiling point; 173° C., vapor pressure; 3.0 mmHg (30° C.)) and diethylene glycol monoethyl ether acetate (boiling point; 217° C., vapor pressure; 0.05 mmHg (20° C.)), for which a binder has a relatively high solubility, is used. On comparison, the boiling point of toluene is 110.6° C. and that of ethyl acetate is 76.8° C. In other words, acid methoxybuthyl and diethylene glycol monoethyl ether acetate vaporize slower than toluene, so that the surface of the printed layer is kept wet for a longer period of time at an ordinary temperature. As a result, the leveling effect may be obtained by leaving the printed layer standing.

Of course, the leveling effect is obtained when the amount of the solvent in the mixed paste is relatively large even if the solvent is toluene or ethyl acetate. The mixed paste, however, is not printed well because the larger the amount of the solvent for solving the binder, the lower the viscosity. As a result, it is not desirable to use toluene or ethyl acetate as the solvent and to increase the solvent amount to obtain the leveling effect.

In other words, when the viscosity of the mixed paste is adjusted to be 40 Pa.s to 50 Pa.s, which is suitable for the screen printing, by adjusting the solvent amount, the leveling effect is not obtained with the solvent amount in the conventional binder dissolution solvent. On the other hand, in the present embodiment, the leveling effect is obtained with the amount of the solvent by which the mixed paste is adjusted to have a viscosity suitable to the screen printing (40 Pa.s to 50Pa.s).

The binder dissolution solvent in the present embodiment may be one kind of binder dissolution solvent or the mixture of at least two kinds of binder dissolution solvent. Note that the mixture of organic solvents has an advantage of freely changing the vaporization speed in response to the amount of the binder included in the mixed paste. For instance, when the amount of the binder included in the mixed paste is small, i.e., when the proportion of the fluorescent substance is relatively high, and when the fluidity of the binder is relatively low, it is possible to adjust the vaporizing speed by using the mixture of solvents including relatively large amount of diethylene glycol monoethyl ether acetate, which is slow in vaporizing. When the amount of the binder included in the mixed paste is relatively large, i.e., when the proportion of the fluorescent substance is relatively low, and when the fluidity of the binder is relatively high, it is possible to adjust the vaporizing speed by using the mixture of solvents including relatively large amount of acid methoxybuthyl, which is fast in vaporizing.

Then, after leveling the printed layer by leaving the printed mixed paste standing for the certain period of time as has been described, the solvent is vaporized and the printed layer is dried by being heated at a predetermined temperature, which is from the boiling point of the binder dissolution solvent to the highest temperature at which the PET used for the substrate does not deform. More specifically, the printed layer is heated at 80° C. to 120° C. for at least 10 minutes.

On the light emitting layer, which has been formed as has been described, the insulation layer is formed in the same manner. In forming the insulation layer, a mixed paste is printed on the surface of the light emitting layer. The mixed paste includes a solvent that has a higher boiling point and a lower vapor pressure than toluene as the mixture used in forming the light emitting layer. With the mixed paste, the leveling effect is obtained. Then, after left at an ordinary temperature, the printed layer undergoes a drying operation. The insulation layer is formed in this way.

The binder used for forming the light emitting layer and the insulation layer may be fluororesin that is a conventional ternary copolymer of vinylidene fluoride, 6 propylene fluoride, and 4 ethylene fluoride. It is desirable to use fluororesin that is a binary copolymer of vinylidene fluoride and 6 propylene fluoride, vinylidene fluoride and 3 ethylene fluoride, or vinylidene fluoride and 3 ethylene chloride fluoride since the fluororesin is resistant to carry currents and requires less power consumption under the same voltage.

Then, on the insulation layer that has been formed in this way, a back electrode is formed according to the same screen printing method using a mixed paste in which an electrically conductive substance such as carbon powder, copper powder, and silver powder is dispersed in a binder. Although the binder for forming the back electrode is not confined to a particular kind of substance, it is effective to use thermosetting fenol resin to prevent the loss of life due to absorbing moisture. This is because the electrically conductive substance is rarely exposed and the absorbing moisture by the electrically conductive substance is prevented since the thermosetting fenol resin is not only water repellent but also resistant to soften even when the electrode temperature rises during the operation. The insulation layer in the EL light emitting element according to the present embodiment includes a relatively less amount of binder and a relatively much amount of barium titanate and titanium oxide, each of which is high in moisture absorbency. Under the circumstances, it is meaningful to increase the water repellency of the back electrode.

The explanation of the specific experiments performed according to the present invention will be given below.

(Experiment 1)

As shown in Table 1, EL light emitting elements EL1 to EL11, each of which has a different proportion (weight-percentage) of high permittivity substance in the insulation layer and a different thickness (μm) of the insulation, are manufactured. The intensities (cd/m²) and the currents (mA/cm²) of the EL light emitting elements EL1 to EL11 are measured when alternative current with voltage of 120 V and frequency of 400 Hz is applied between the front electrode and the back electrode.

The high permittivity substance is barium ranging from 0.8 to 1.5 μm in size.

Note that the conditions other than the insulation layers in the EL light emitting elements EL1 to EL11 are all the same. For instance, the size of the fluorescent substance in the light emitting layers is set to be 30 μm on average, the proportion of the fluorescent substance is set to be 85% by weight of the light emitting layer, and the thickness of the light emitting layers is set to be 40 μm. The copolymers, vinylidene fluoride and 6 propylene fluoride are used for the binders for the insulation layers and the light emitting layers, respectively. Thermosetting fenol resin is used for the binder for forming the back electrodes. Acid methoxybuthyl is used as the dissolution solvent for copolymers, the vinylidene fluoride and the 6 propylene fluoride. The ratio of the acid methoxybuthyl to the binder is 71% to 29% by weight.

TABLE 1

| | HIGH PERMITTIVITY | | | | | |
|---|---|---|---|---|---|---|
| | SUBSTANCE | INSULATION | | | FLUORESCENT | |
| | (BARIUM) | LAYER | | | SUBSTANCE | |
| EL | PROPORTION | THICKNESS | INTENSITY | CURRENT | PROPORTION | |
| NUMBER | (WEIGHT-PERCENTAGE) | (μm) | (cd/m²) | (mA/cm²) | (WEIGHT-PERCENTAGE) | BINDER |
| EL1 | 65 | 25 | 82 | 0.24 | 85 wt % | VINYLIDENE FLUORIDE + |
| EL2 | 65 | 35 | 78 | 0.23 | THICKNESS | 6 PROPYLENE FLUORIDE |
| EL3 | 75 | 15 | 85 | 0.23 | 40 μm | |
| EL4 | 75 | 25 | 106 | 0.22 | | |
| EL5 | 75 | 35 | 85 | 0.20 | | |
| EL6 | 85 | 15 | 86 | 0.20 | | |
| EL7 | 85 | 25 | 108 | 0.18 | | |
| EL8 | 85 | 35 | 90 | 0.16 | | |
| EL9 | 90 | 15 | 88 | 0.18 | | |
| EL10 | 90 | 25 | 90 | 0.15 | | |
| EL11 | 90 | 35 | 85 | 0.13 | | |

As shown in Table 1, as the high permittivity substance proportion is increased, the intensity is improved and the current value is decreased.

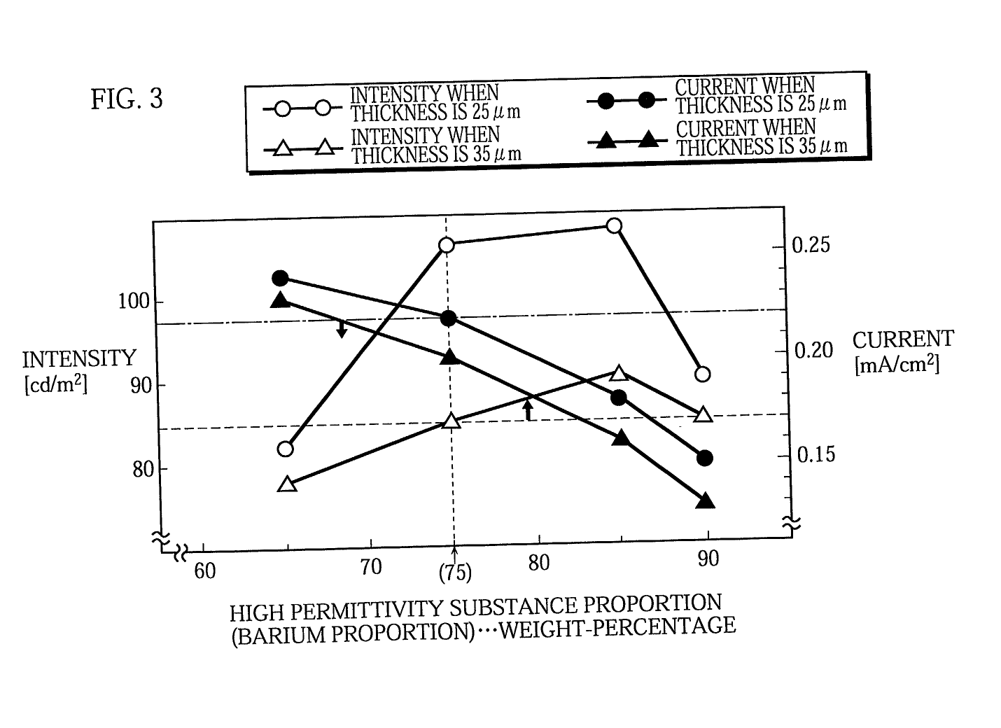

FIG. 3 is a plot showing the relations between high permittivity substance proportions and intensities, and between the high permittivity substance proportions and current values of the insulation layers with the same thickness according to the data on the EL light emitting elements EL1, EL4, EL7, and EL10, and the EL light emitting elements EL2, EL5, EL8, and EL11. In FIG. 3, the horizontal axis represents the high permittivity proportions (weight-percentage) and the vertical axes represents the intensities (cd/m²) and the current values (mA/m²).

As shown in FIG. 3, the higher the proportion of the high permittivity substance in insulation layer, the higher the intensity. On the other hand, the higher the high permittivity substance proportion, the smaller the current value.

The intensity of an EL light emitting element having the insulation layer whose thickness is 25 μm is noticeably increased when the proportion reaches 75% by weight of the insulation layer.

When the proportion reaches 85% by weight of the insulation layer, the intensity starts to decrease and, on the other hand, the current value continues to decrease. In addition, when the proportion exceeds 90% by weight of the insulation layer, the printing accuracy deteriorates. As a result, it is desirable to set the proportion at 85 to 90% by weight of the insulation layer in order to obtain a relatively high intensity with less power.

Further, an EL light emitting element that is manufactured using toluene as the solvent in the mixed paste and the EL light emitting elements EL1 to EL11 are operated under the same condition as has been described, and the outward appearances are compared. When the proportion of the high permittivity substance is around 75% by weight of the insulation layer, black points are observed for the EL light emitting element using toluene. On the other hand, even when the proportion exceeds 75% by weight of the insulation layer, no black point is observed for any of the EL light emitting elements EL1 to EL11 The quality difference shows that the aforementioned leveling effect is obtained for the EL light emitting elements EL1 to EL11 even when the proportion of the high permittivity substance is increased.

(Experiment 2)

As shown in Table 2, EL light emitting elements EL12 to EL16, each of which has a different proportion (weight-percentage) of fluorescent substance in the light emitting layer and has the same thickness of 40 μm are manufactured. The intensities (cd/m²) of the EL light emitting elements EL12 to EL16 are measured when alternative current with voltage of 120 V and frequency of 400 Hz as in Experiment 1 is applied between the front electrode and the back electrode. Note that the conditions other than the light emitting layers in the EL light emitting elements EL12 to EL16 are all the same. For instance, the proportion of the high permittivity substance in the insulation layers is set to be 75% by weight, and the thickness of the insulation layers is set to be 25 μm.

TABLE 2

| | | | | HIGH |
|---|---|---|---|---|
| | FLUORESCENT | | | PERMITTIVITY |
| | SUBSTANCE | | | SUBSTANCE |
| | PROPORTION | | | PROPORTION |
| EL | (WEIGHT- | INTENSITY | | (WEIGHT- |
| NUMBER | PERCENTAGE) | (cd/m²) | BINDER | PERCENTAGE) |
| EL12 | 65 | 60 | VINYLIDENE FLUORIDE + | 75 wt % |
| EL13 | 75 | 85 | 6 PROPYLENE FLUORIDE | THICKNESS |
| EL14 | 80 | 97 | | 25 μm |
| EL4 | 85 | 104 | | |
| EL15 | 88 | 116 | | |
| EL16 | 92 | 118 | | |

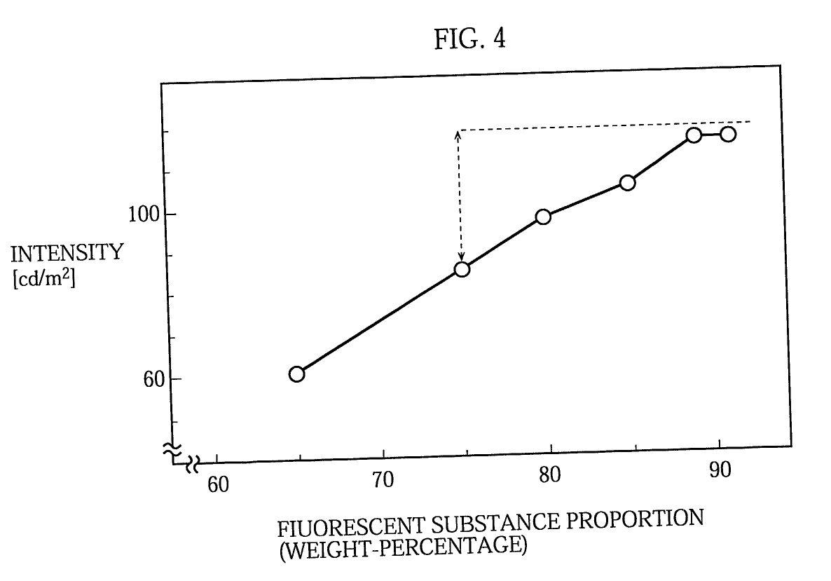

FIG. 4 is a plot showing the relations between fluorescent substance proportions (weight-percentage) and intensities according to experimental results in Table 2.

As shown in Table 2, the higher the fluorescent substance proportion, the higher the intensity. Table 2 shows that the intensity increases as the increase of the fluorescent substance proportion when the fluorescent substance proportion is equal to or higher than 65% by weight of the light emitting layer. The fluorescent substance proportion, however, should be set at equal to or higher than 75% by weight of the insulation layer since it is desirable to have the highest possible intensity relative to the maximum intensity.

In addition, until the fluorescent substance proportion reaches about 75% by weight of the light emitting layer, a phenomenon is observed in which not the light emitting layer as a whole but each particle of the fluorescent substance in the light emitting layer emits (graininess). The graininess is not observed, however, after the fluorescent substance proportion reaches about 75% by weight of the light emitting layer.

On the other hand, when the fluorescent substance proportion exceeds 92% by weight of the light emitting layer, the printing accuracy deteriorates, leading to the decrease of the intensity. As a result, it is desirable to set the proportion of the fluorescent substance in a light emitting layer at equal to or smaller than 92% by weight.

(Experiment 3)

As shown in Table 3, EL light emitting elements EL17 and EL18, each of which uses a fluororesin that is a ternary copolymer as the binder of the insulation layer and the light emitting layer, are manufactured. The currents (mA/cm²) of the EL light emitting elements EL17 and EL18 and of the EL light emitting elements EL4 and EL7, each of which uses a fluororesin that is a binary copolymer as the binder, are measured when an alternative current with voltage of 120 V and frequency of 400 Hz is applied between the front electrode and the back electrode. Here, the ternary copolymer fluororesin is a copolymer of vinylidene fluoride, 6 propylene fluoride, and 4 ethylene fluoride. Note that in each of the EL light emitting elements EL4, EL7, EL17, and EL18, the conditions of the light emitting layer and the insulation layers are set as given below. The fluorescent substance proportion in the light emitting layer is set at 85% by weight, and the thickness of the light emitting layer is set at 40 μm. The high permittivity substance proportion in the insulation layer is set at 75% and 85% by weight, and the thickness of the insulation layer is set at 25 μm.

TABLE 3

| | BARIUM | | FLUORESCENT | |
|---|---|---|---|---|
| | PROPORTION | | SUBSTANCE | |
| EL | (WEIGHT- | CURRENT | PROPORTION | FLUORORUBBER |
| NUMBER | PERCENTAGE) | (mA/cm²) | PERCENTAGE | BINDER |
| EL4 | 75 THICKNESS25 μm | 0.22 | 85 wt % | VINYLIDENE FLUORIDE + |
| EL7 | 85 THICKNESS25 μm | 0.18 | THICKNESS | 6 PROPYLENE FLUORIDE |
| | | | 40 μm | |
| EL17 | 75 THICKNESS25 μm | 0.31 | 85 wt % | VINYLIDENE FLUORIDE + |
| EL18 | 85 THICKNESS25 μm | 0.38 | THICKNESS | 6 PROPYLENE FLUORIDE |
| | | | 40 μm | 4 ETHYLENE FLUORIDE |

As shown in Table 3, the current of the EL light emitting element in which the binary copolymer fluororesin is used as the binder is lower than the current of the EL light emitting element in which the ternary copolymer fluororesin is used.

As a result, the binary copolymer fluororesin is more desirable than the ternary copolymer fluororesin in saving power.

Note that the present invention is not limited to the embodiment that has been described. The present invention may be realized by various modifications given below.

The solvent having a higher boiling point than toluene is used as the mixed paste in the aforementioned embodiment. It is possible to include toluene and ethyl acetate in the mixed paste only if a certain amount of the solvent that is large enough to obtain the leveling effect is included in the mixed paste.

The fluorescent substance proportion and the high permittivity substance proportion are set high in both of the light emitting layer and the insulation layer by applying the screen printing method using the solvents with which the leveling effect is obtained in the aforementioned embodiment. When either of the insulation layer and the light emitting layer is formed according to the screen printing method, abnormal discharge occurs less frequently than in an EL light emitting element in which both of the insulation layer and the light emitting layer are formed using the solvent having a high vaporizing speed such as toluene and ethyl acetate, by which the leveling effect is not appropriately obtained. This is because forming of either of the layers according to the screen printing method using the solvent that has the leveling effect reduce reduces the frequency of interstice occurrence in the layer.

It is desirable, however, to form both of the layers according to the screen method that has been described to reduce the frequency of abnormal discharge occurrence, to improve intensity, and to reduce the voltage at the same time. This is because to form both of the layers according to the screen method further reduces the frequency of the interstice appearance compared with the forming either of the layers.

It is possible to increase the intensity and save power only by increasing the proportion of the fluorescent substance and the high permittivity substance even if the thickness of the light emitting layer and the insulation layer remains the same as in a conventional EL light emitting element. The effects of the intensity increase and the voltage decrease, however, are more noticeable when the thickness is set thinner.

In addition, it is acceptable to form only the light emitting layer according to the screen printing method that has been described in the preferred embodiment for reducing the frequency of the interstice appearance, to set the fluorescent substance proportion higher, and to set the light emitting layer thickness to be 40 μm or thinner. In this case, the amount of the fluorescent substance per unit of space is higher and the layer is thinner, so that the capacitance of the EL light emitting element is increased. As a result, the intensity is improved and the voltage is decreased. On the other hand, it is also acceptable to form only the insulation layer according to the screen printing method for reducing the frequency of the interstice appearance, to set the high permittivity substance proportion higher, and to set the insulation layer thickness to be 35 μm or thinner. In this case also, the intensity is improved and the voltage is decreased. Of course, it is more desirable to form both of the light emitting layer and the insulation layer according to the screen printing method and to set the fluorescent substance proportion, the high permittivity substance, and the thickness as has been described in the preferred embodiment.

When the surface of the insulation layer is even by the leveling effect, the back electrode is formed according to the screen printing method using the conventional mixed paste. When only the light emitting layer has been formed according to the preferred embodiment, however, the surface of the insulation layer is considerably uneven. In this case, it is desirable to form the back electrode according to the screen printing method using the solvent having a relatively high boiling point to obtain the leveling effect.

When an electrode material of aluminum foil or copper foil attached on a resin film is used as the back electrode, it is not necessary to manufacture an EL light emitting element according to the present invention by forming the layers in the order described in the preferred embodiment, light emitting layer-insulation layer-back electrode. It is possible to manufacture the EL light emitting element by forming the insulation layer according to the screen method on the back electrode first, then forming the light emitting layer on the insulation layer, and attaching the PET film onto which the ITO is evaporated onto the light emitting layer by heat.

Although the present invention has been fully described by way of examples with reference to the accompanying drawings, it is to be noted that various changes and modifications will be apparent to those skilled in the art. Therefore, unless such changes and modifications depart from the scope of the present invention, they should by construed as being included therein.

What is claimed is:

1. An EL light emitting element manufacturing method, comprising:
a first electrode forming process for forming a first electrode on a substrate;
a light emitting layer forming process for forming a light emitting layer on the first electrode;
an insulation layer forming process for forming an insulation layer on the light emitting layer; and
a second electrode forming process for forming a second electrode on the insulation layer, wherein the light emitting layer forming process includes:
a printing step for printing a mixed paste for forming the light emitting layer, the mixed paste being a dispersion of a fluorescent substance in a binder dissolved in one of a solvent that has a higher boiling point than toluene and a mixture of solvents including a solvent that has a higher boiling point than toluene, according to a screen printing method; and
a leaving step for leaving the printed mixed paste standing.

2. The EL light emitting element manufacturing method according to claim 1, wherein the solvent that has the higher boiling point than toluene is one of acid methoxybuthyl and diethylene glycol monoethyl ether acetate.

3. The EL light emitting element manufacturing method according to claim 2, wherein the mixed paste is printed at the printing step so that a proportion of the fluorescent substance is ultimately at least 75% by weight of the light emitting layer.

4. The EL light emitting element manufacturing method according to claim 3, wherein the mixed paste is printed at the printing step so that thickness of the light emitting layer is ultimately equal to or smaller than 40 μm.

5. The EL light emitting element manufacturing method according to claim 4, wherein the binder is a binary copolymer fluororesin.

6. The EL light emitting element manufacturing method according to claim 3, wherein the binder is a binary copolymer fluororesin.

7. The EL light emitting element manufacturing method according to claim 6, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

8. The EL light emitting element manufacturing method according to claim 5, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

9. The EL light emitting element manufacturing method according to claim 8, wherein the second electrode is formed in the second electrode forming process by attaching an electrically conductive substance using a thermosetting, water-repellent resin.

10. The EL light emitting element manufacturing method according to claim 7, wherein the second electrode is formed in the second electrode forming process by attaching an electrically conductive substance using a thermosetting, water-repellent resin.

11. An EL light emitting element manufacturing method, comprising:
a first electrode forming process for forming a first electrode on a substrate;
a light emitting layer forming process for forming a light emitting layer on the first electrode;
an insulation layer forming process for forming an insulation layer on the light emitting layer; and
a second electrode forming process for forming a second electrode on the insulation layer, wherein the insulation layer forming process includes:
a printing step for printing a mixed paste for forming the insulation layer, the mixed paste being a dispersion of a dielectric substance in a binder dissolved in one of a solvent that has a higher boiling point than toluene and a mixture of solvents including a solvent that has a higher boiling point than toluene, according to a screen printing method; and
a leaving step for leaving the printed mixed paste standing.

12. The EL light emitting element manufacturing method according to claim 11, wherein the solvent that has the higher boiling point than toluene is one of acid methoxybuthyl and diethylene glycol monoethyl ether acetate.

13. The light emitting element manufacturing method according to claim 12, wherein the mixed paste is printed at the printing step so that a proportion of the dielectric substance is ultimately at least 75% by weight of the insulation layer.

14. The EL light emitting element manufacturing method according to claim 13, wherein the mixed paste is printed at the printing step so that thickness of the insulation layer is ultimately equal to or smaller than 35 μm.

15. The EL light emitting element manufacturing method according to claim 14, wherein the binder is a binary 3 copolymer fluororesin.

16. The EL light emitting element manufacturing method according to claim 13, wherein the binder is a binary copolymer fluororesin.

17. The EL light emitting element manufacturing method according to claim 16, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

18. The EL light emitting element manufacturing method according to claim 15, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

19. The EL light emitting element manufacturing method according to claim 18, wherein the second electrode is formed in the second electrode forming process by attaching an electrically conductive substance using a thermosetting, water-repellent resin.

20. The EL light emitting element manufacturing method according to claim 17, wherein the second electrode is formed in the second electrode forming process by attaching an electrically conductive substance using a thermosetting, water-repellent resin.

21. An EL light emitting element manufacturing method, comprising:
a first electrode forming process for forming a first electrode on a substrate;
a light emitting layer forming process for forming a light emitting layer on the first electrode;
an insulation layer forming process for forming an insulation layer on the light emitting layer; and
a second electrode forming process for forming a second electrode on the insulation layer, wherein the light emitting layer forming process includes:
a first printing step for printing a first mixed paste for forming the light emitting layer, the first mixed paste being a dispersion of a fluorescent substance in a binder dissolved in one of a solvent that has a higher boiling point than toluene and a mixture of solvents including a solvent that has a higher boiling point than toluene, according to a screen printing method so that a proportion of the fluorescent substance is ultimately at least 75% by weight of the light emitting layer; and
a first leaving step for leaving the printed first mixed paste standing, and
the insulation layer forming process includes:
a second printing step for printing a second mixed paste for forming the insulation layer, the second mixed paste being a dispersion of a dielectric substance in a binder dissolved in one of a solvent that has a higher boiling point than toluene and a mixture of solvents including a solvent that has a higher boiling point than toluene, according to the screen printing method so that a proportion of the dielectric substance is ultimately at least 75% by weight of the insulation layer; and
a second leaving step for leaving the printed second mixed paste standing.

22. The EL light emitting element manufacturing method according to claim 21, wherein the solvent that has the higher boiling point than toluene used at the first and second printing steps is one of acid methoxybuthyl and diethylene glycol monoethyl ether acetate.

23. The EL light emitting element manufacturing method according to claim 22, wherein
the first mixed paste is printed at the first printing step so that thickness of the light emitting layer is ultimately from 15 to 40 μm, and
the second mixed paste is printed at the second printing step so that thickness of the insulation layer is ultimately from 15 to 35 μm.

24. The EL light emitting element manufacturing method according to claim 23, wherein the binder used at at least one of the first and second printing steps is a binary copolymer fluororesin.

25. The EL light emitting element manufacturing method according to claim 22, wherein the binder used at at least one of the first and second printing steps is a binary copolymer fluororesin.

26. The EL light emitting element manufacturing method according to claim 25, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

27. The EL light emitting element manufacturing method according to claim 24, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

28. The EL light emitting element manufacturing method according to claim 27, wherein the second electrode is formed in the second electrode forming process by attaching an electrically conductive substance using a thermosetting, water-repellent resin.

29. The EL light emitting element manufacturing method according to claim 26, wherein the second electrode is formed in the second electrode forming process by attaching an electrically conductive substance using a thermosetting, water-repellent resin.

30. An EL light emitting element manufacturing method, comprising:
a first electrode forming process for forming a first electrode on a substrate;
an insulation layer forming process for forming an insulation layer on the first electrode;
a light emitting layer forming process for forming a light emitting layer on the insulation layer; and
a second electrode forming process for forming a second electrode on the light emitting layer, wherein the light emitting layer forming process includes:
a printing step for printing a mixed paste for forming the light emitting layer, the mixed paste being a dispersion of a fluorescent substance in a binder dissolved in one of a solvent that has a higher boiling point than toluene and a mixture of solvents including a solvent that has a higher boiling point than toluene, according to a screen printing method; and
a leaving step for leaving the printed mixed paste standing.

31. The EL light emitting element manufacturing method according to claim 30, wherein the solvent that has the higher boiling point than toluene is one of acid methoxybuthyl and diethylene glycol monoethyl ether acetate.

32. The EL light emitting element manufacturing method according to claim 31, wherein the mixed paste is printed at the printing step so that a proportion of the fluorescent substance is ultimately at least 75% by weight of the light emitting layer.

33. The EL light emitting element manufacturing method according to claim 32, wherein the mixed paste is printed at the printing step so that thickness of the light emitting layer is ultimately equal to or smaller than 40 μm.

34. The EL light emitting element manufacturing method according to claim 33, wherein the binder is a binary copolymer fluororesin.

35. The EL light emitting element manufacturing method according to claim 32, wherein the binder is a binary copolymer fluororesin.

36. The EL light emitting element manufacturing method according to claim 35, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

37. The EL light emitting element manufacturing method according to claim 34, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

38. The EL light emitting element manufacturing method according to claim 37, wherein the first electrode is formed in the first electrode forming process by attaching an electrically conductive substance using a thermosetting, water-repellent resin.

39. The EL light emitting element manufacturing method according to claim 36, wherein the first electrode is formed in the first electrode forming process by attaching an electrically conductive substance using a thermosetting, water-repellent resin.

40. An EL light emitting element manufacturing method, comprising:
a first electrode forming process for forming a first electrode on a substrate;
an insulation layer forming process for forming an insulation layer on the first electrode;
a light emitting layer forming process for forming a light emitting layer on the insulation layer; and
a second electrode forming process for forming a second electrode on the light emitting layer, wherein the insulation layer forming process includes:
a printing step for printing a mixed paste for forming the insulation layer, the mixed paste being a dispersion of a dielectric substance in a binder dissolved in one of a solvent that has a higher boiling point than toluene and a mixture of solvents including a solvent that has a higher boiling point than toluene, according to a screen printing method; and
a leaving step for leaving the printed mixed paste standing.

41. The EL light emitting element manufacturing method according to claim 40, wherein the solvent that has the higher boiling point than toluene is one of acid methoxybuthyl and diethylene glycol monoethyl ether cetate.

42. The EL light emitting element manufacturing method according to claim 41, wherein the mixed paste is printed at the printing step so that a proportion of the dielectric substance is ultimately at least 75% by weight of the insulation layer.

43. The EL light emitting element manufacturing method according to claim 42, wherein the mixed paste is printed at the printing step so that thickness of the insulation layer is ultimately equal to or smaller than 35 μm.

44. The EL light emitting element manufacturing method according to claim 43, wherein the binder is a binary copolymer fluororesin.

45. The EL light emitting element manufacturing method according to claim 42, wherein the binder is a binary copolymer fluororesin.

46. The EL light emitting element manufacturing method according to claim 45, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

47. The EL light emitting element manufacturing method according to claim 44, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

48. The EL light emitting element manufacturing method according to claim 47, wherein the first electrode is formed in the first electrode forming process by attaching an electrically conductive substance using a thermosetting, water-repellent resin.

49. The EL light emitting element manufacturing method according to claim 46, wherein the first electrode is formed in the first electrode forming process by attaching an electrically conductive substance using a thermosetting, water-repellent resin.

50. An EL light emitting element manufacturing method, comprising:
a first electrode forming process for forming a first electrode on a substrate;
an insulation layer forming process for forming an insulation layer on the first electrode;
a light emitting layer forming process for forming a light emitting layer on the insulation layer; and
a second electrode forming process for forming a second electrode on the light emitting layer, same as claim 40 wherein the insulation layer forming process includes:
a first printing step for printing a first mixed paste for forming the insulation layer, the first mixed paste being a dispersion of a dielectric substance in a binder dissolved in one of a solvent that has a higher boiling point than toluene and a mixture of solvents including a solvent that has a higher boiling point than toluene, according to a screen printing method so that a proportion of the dielectric substance is ultimately at least 75% by weight of the insulation layer; and
a first leaving step for leaving the printed first mixed paste standing, and
the light emitting layer forming process includes:
a second printing step for printing a second mixed paste for forming the light emitting layer, the second mixed paste being a dispersion of a fluorescent substance in a binder dissolved in one of a solvent that has a higher boiling point than toluene and a mixture of solvents including a solvent that has a higher boiling point than toluene, according to the screen printing method so that a proportion of the fluorescent substance is ultimately at least 75% by weight of the light emitting layer; and
a second leaving step for leaving the second mixed paste standing.

51. The EL light emitting element manufacturing method according to claim 50, wherein the solvent that has the higher boiling point than toluene used at the first and second printing steps is one of acid methoxybuthyl and diethylene glycol monoethyl ether acetate.

52. The EL light emitting element manufacturing method according to claim 51, wherein
the first mixed paste is printed at the first printing step so that thickness of the insulation layer is ultimately from 15 to 35 μm, and the second mixed paste is printed at the second printing step so that thickness of the light emitting layer is ultimately from 15 to 40 μm.

53. The EL light emitting element manufacturing method according to claim 52, wherein the binder used at at least one of the first and second printing steps is a binary copolymer fluororesin.

54. The EL light emitting element manufacturing method according to claim 51, wherein the binder used at at least one of the first and second printing steps is a binary copolymer fluororesin.

55. The EL light emitting element manufacturing method according to claim 54, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

56. The EL light emitting element manufacturing method according to claim 53, wherein the binary copolymer fluororesin is one of a vinylidene fluoride-6 propylene fluoride copolymer, a vinylidene fluoride-3 ethylene fluoride copolymer, and a vinylidene fluoride-3 etheylene chloride fluoride copolymer.

57. The EL light emitting element manufacturing method according to claim 56, wherein the first electrode is formed in the first electrode forming process by attaching an electrically conductive substance using a thermosetting, water-repellent resin.

58. The EL light emitting element manufacturing method according to claim 55, wherein the first electrode is formed in the first electrode forming process by attaching an electrically conductive substance using a thermosetting, water-repellent resin.

59. An EL light emitting element manufacturing method, comprising:
a first electrode forming process for forming a first electrode on a substrate;
a light emitting layer forming process for forming a light emitting layer on the first electrode;
an insulation layer forming process for forming an insulation layer on the light emitting layer; and
a second electrode forming process for forming a second electrode on the insulation layer, wherein the light emitting layer forming process includes:
a first printing step for printing a first mixed paste for forming the light emitting layer, the first mixed paste being a dispersion of a fluorescent substance in a binder dissolved in one of a solvent that has a higher boiling point than toluene and a mixture of solvents including a solvent that has a higher boiling point than toluene, according to a screen printing method so that a proportion of the fluorescent substance is ultimately from 75 to 92% by weight of the light emitting layer and thickness of the light emitting layer is ultimately from 15 to 40 μm;
a first leaving step for leaving the printed first mixed paste standing; and
a first heating step for heating the first mixed paste that has been left standing, and
the insulation layer forming process includes:
a second printing step for printing a second mixed paste for forming the insulation layer, the second mixed paste being a dispersion of a dielectric substance in a binder dissolved in one of a solvent that has a higher boiling point than toluene and a mixture of solvents including a solvent that has a higher boiling point than toluene, according to the screen printing method so that a proportion of the dielectric substance is ultimately from 75 to 90% by weight of the insulation layer and thickness of the insulation layer is ultimately from 15 to 35 μm;
a second leaving step for leaving the printed second mixed paste standing; and
a second heating step for heating the second mixed paste that has been left standing.

60. The EL light emitting element manufacturing method according to claim 59, wherein the solvent that has the higher boiling point than toluene used at the first and second printing steps is one of acid methoxybuthyl and diethylene glycol monoethyl ether acetate.

61. The EL light emitting element manufacturing method according to claim 60, wherein the second electrode is formed in the second electrode forming process by attaching an electrically conductive substance using a thermosetting, water-repellent resin.

62. An EL light emitting element manufacturing method, comprising:
a first electrode forming process for forming a first electrode on a substrate;
an insulation layer forming process for forming an insulation layer on the first electrode;
a light emitting layer forming process for forming a light emitting layer on the insulation layer; and
a second electrode forming process for forming a second electrode on the light emitting layer, wherein the insulation layer forming process includes:
a first printing step for printing a first mixed paste for forming the insulation layer, the first mixed paste being a dispersion of a dielectric substance in a binder dissolved in one of a solvent that has a higher boiling point than toluene and a mixture of solvents including a solvent that has a higher boiling point than toluene, according to a screen printing method so that a proportion of the dielectric substance is ultimately from 75 to 90% by weight of the insulation layer and thickness of the insulation layer is ultimately from 15 to 35 μm;
a first leaving step for leaving the printed first mixed paste standing; and
a first heating step for heating the first mixed paste that has been left standing, and
the light emitting layer forming process includes:
a second printing step for printing a second mixed paste, the second mixed paste being a dispersion of a fluorescent substance in a binder dissolved in one of a solvent that has a higher boiling point than toluene and a mixture of solvents including a solvent that has a higher boiling point than toluene, according to the screen printing method so that a proportion of the fluorescent substance is ultimately from 75 to 92% by weight of the light emitting layer and thickness of the light emitting layer is ultimately from 15 to 40 μm;
a second leaving step for leaving the printed second mixed paste standing; and
a second heating step for heating the second mixed paste that has been left standing.

63. The EL light emitting element manufacturing method according to claim 62, wherein the solvent that has the higher boiling point than toluene used at the first and second printing steps is one of acid methoxybuthyl and diethylene glycol monoethyl ether acetate.

64. The EL light emitting element manufacturing method according to claim 63, wherein the first electrode is formed in the first electrode forming process by attaching an electrically conductive substance using a thermosetting, water-repellent resin.
